(19) United States
(12) Patent Application Publication
(10) Pub. No.: US 2023/0393414 A1
(43) Pub. Date: Dec. 7, 2023

(54) MEDIUM-FREE PROJECTION SYSTEM

(71) Applicant: Zhejiang Crystal-Optech Co., Ltd., Taizhou, Zhejiang (CN)

(72) Inventors: Xiaolu Lin, Taizhou (CN); Honghu Ma, Taizhou (CN); Fenglei Liu, Taizhou (CN)

(73) Assignee: Zhejiang Crystal-Optech Co., Ltd., Taizhou, Zhejiang (CN)

(21) Appl. No.: 18/034,043

(22) PCT Filed: Dec. 29, 2021
(86) PCT No.: PCT/CN2021/142562

§ 371 Date: Apr. 26, 2023

(30) Foreign Application Priority Data
Mar. 17, 2021 (CN) 202110288295.7

(51) Int. Cl. G02B 30/56; G02B 17/08

(52) U.S. Cl. CPC G02B 30/56; G02B 17/0816

(57) ABSTRACT

Provided is a medium-free projection system, comprising: a divergent beam emitted from a light source is collimated and homogenized by a light homogenizing rod and a first Fresnel lens and serves as incident light of a thin film crystal liquid crystal display screen, and a beam emitted from the thin film crystal liquid crystal display screen passes through a collimating optical element, and is converged by an imaging optical assembly into a target region to form an image, so that each point of the beam on an image plane fills an eye box. That is, the image suspended in air can be viewed by naked eyes in the range of the eye box, thereby realizing medium-free projection.

### CROSS-REFERENCE TO RELATED APPLICATION

The present disclosure claims the priority to the Chinese patent application with the filing No. 202110288295.7 filed on Mar. 17, 2021 with the China National Intellectual Property Administration and entitled “Medium-free Projection System”, the contents of which are incorporated herein by reference in entirety.

### TECHNICAL FIELD

The present disclosure relates to the technical field of optics, and in particular to a medium-free projection system.

### BACKGROUND ART

With the rapid development of science and technologies, the medium-free projection technology, by which an image can be seen without a medium screen, is gradually mature. As the medium-free projection technologies can image in the air without any medium, it is also widely applied to human-computer interaction systems in automobiles.

When a medium-free projection system in the related art images in a target region, the image has relatively low brightness and uniformity, and the actual use requirements can hardly be met.

### SUMMARY

The present disclosure provides a medium-free projection system, so as to solve the problem that the image brightness and brightness uniformity are poor when the existing medium-free projection system is imaging, so as to at least overcome the above shortcomings of related art.

An embodiment of the present disclosure provides a medium-free projection system, wherein the medium-free projection system may include: a light source; and a light homogenizing rod, a first Fresnel lens, a thin film crystal liquid crystal display screen, a collimating optical element, and an imaging optical assembly that are arranged in sequence along a light emergent direction, wherein a divergent beam emitted from the light source is collimated and homogenized by the light homogenizing rod and the first Fresnel lens and then serves as an incident light of the thin film crystal liquid crystal display screen, and the beam emitted from the thin film crystal liquid crystal display screen, after passing through the collimating optical element, is converged in a target region by the imaging optical assembly to image, so that the beam at each point on an imaging plane fills an eye box.

Optionally, the thin film crystal liquid crystal display screen may be a display panel having a transmission function.

Optionally, the light source may be an LED light source.

Optionally, the imaging optical assembly may include a first reflecting mirror and a second reflecting mirror that are arranged in sequence along the light emergent direction, wherein the beam emitted from the collimating optical element is converged in the target region through the first reflecting mirror and the second reflecting mirror in sequence to image.

Optionally, a surface of the first reflecting mirror and a surface of the second reflecting mirror may be both free curved surfaces.

Optionally, a diffusion film may be provided at a light incident side of the thin film crystal liquid crystal display screen.

Optionally, an optical axis of the LED light source and an optical axis of the thin film crystal liquid crystal display screen may form a certain included angle.

Optionally, the light homogenizing rod may be a hollow square conical rod, wherein an inner wall of the hollow square conical rod is plated with a reflective film, a top surface of the hollow square conical rod is the light incident side, a bottom surface of the hollow square conical rod is a light emergent side, and the top surface of the hollow square conical rod has an area less than that of the bottom surface of the hollow square conical rod.

Optionally, the collimating optical element may be an imaging lens.

Optionally, the imaging lens may be a spherical lens, an aspherical lens or a second Fresnel lens.

Optionally, the collimating optical element may be a third reflecting mirror, and a surface of the third reflecting mirror may be a spherical surface, an aspherical surface, or a free curved surface.

Optionally, the medium-free projection system further may include a fold-back optical assembly, and the fold-back optical assembly is configured to fold an optical path.

Optionally, the fold-back optical assembly may be one or more reflecting mirrors, and the optical path is folded by the reflecting mirror or mirrors.

The present disclosure includes at least the following beneficial effects:

The present disclosure provides a medium-free projection system, wherein the medium-free projection system includes: the light source; and the light homogenizing rod, the first Fresnel lens, the thin film crystal liquid crystal display screen, the collimating optical element, and the imaging optical assembly that are arranged in sequence along the light emergent direction, wherein the divergent beam emitted from the light source is collimated and homogenized by the light homogenizing rod and the first Fresnel lens and then serves as an incident light of the thin film crystal liquid crystal display screen, and the beam emitted from the thin film crystal liquid crystal display screen passes through the collimating optical element and is converged in the target region by the imaging optical assembly to image, so that the beam at each point of an imaging plane fills the eye box. A real image can be observed by naked eyes in the range of the eye box, thus realizing medium-free projection. By providing the light homogenizing rod and the first Fresnel lens between the light source and the thin film crystal liquid crystal display screen, the beam emitted from the light source can be primarily collimated and homogenized, so that the brightness and uniformity of the image are improved in an image source stage. Then the collimating optical element is provided on the light emergent side of the thin film crystal liquid crystal display screen, the main lights of the beam of various fields of view emitted by the thin film crystal liquid crystal display screen are modified again through the collimating optical element, so that the main lights of various fields of view of the beam for the imaging part are nearly parallel, thus further improving the brightness and brightness uniformity of the imaging in the target region, further realizing clearer image display in the target region, and improving the imaging quality of the final image and the use experience of the users. Meanwhile, when the medium-free projection is realized with the above device, the manufacturing cost can be reduced.

### BRIEF DESCRIPTION OF DRAWINGS

In order to more clearly illustrate technical solutions of embodiments of the present disclosure, drawings which need to be used in the embodiments will be introduced briefly below, and it should be understood that the drawings below merely show some embodiments of the present disclosure, therefore, they should not be considered as limitation to the scope, and those ordinarily skilled in the art still could obtain other relevant drawings according to these drawings, without using any creative efforts.

FIG. 1 is a first structural schematic diagram of a medium-free projection system provided in an embodiment of the present disclosure;

FIG. 2 is a second structural schematic diagram of a medium-free projection system provided in an embodiment of the present disclosure;

FIG. 3 is a third structural schematic diagram of a medium-free projection system provided in an embodiment of the present disclosure;

FIG. 4 is a fourth structural schematic diagram of a medium-free projection system provided in an embodiment of the present disclosure; and

FIG. 5 is a fifth structural schematic diagram of a medium-free projection system provided in an embodiment of the present disclosure.

Reference Signs: 1—image generation unit; 11—light source; 111—beam; 12—light homogenizing rod; 13—first Fresnel lens; 14—diffusion film; 15—thin film crystal liquid crystal display screen; 2—collimating optical element; 21—imaging lens; 22—third reflecting mirror; 3—first reflecting mirror; 4—second reflecting mirror; 5—imaging plane position; 6—eye box.

### DETAILED DESCRIPTION OF EMBODIMENTS

In order to make objectives, technical solutions, and advantages of the embodiments of the present disclosure clearer, the technical solutions in the embodiments of the present disclosure will be described clearly and completely below with reference to the drawings in the embodiments of the present disclosure. Apparently, the embodiments described are some but not all embodiments of the present disclosure. Generally, components in the embodiments of the present disclosure, as described and shown in the drawings herein, may be arranged and designed in various different configurations.

Therefore, the detailed description below of the embodiments of the present disclosure provided in the drawings is not intended to limit the claimed scope of the present disclosure, but merely illustrates chosen embodiments of the present disclosure. It should be noted that various features in the embodiments of the present disclosure may be combined with each other without conflict, and the combined embodiments still fall within the scope of protection of the present disclosure.

It should be noted that similar reference signs and letters represent similar items in the following drawings; therefore, once a certain item is defined in one drawing, it is not needed to be defined or explained in subsequent drawings.

In the description of the present disclosure, it should be indicated that terms such as “first”, “second”, and “third” are merely for distinguishing the description, but should not be construed as indicating or implying importance in the relativity.

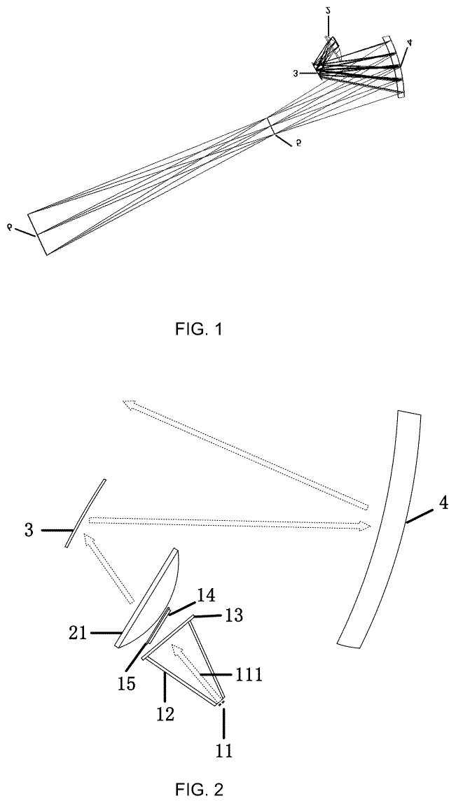

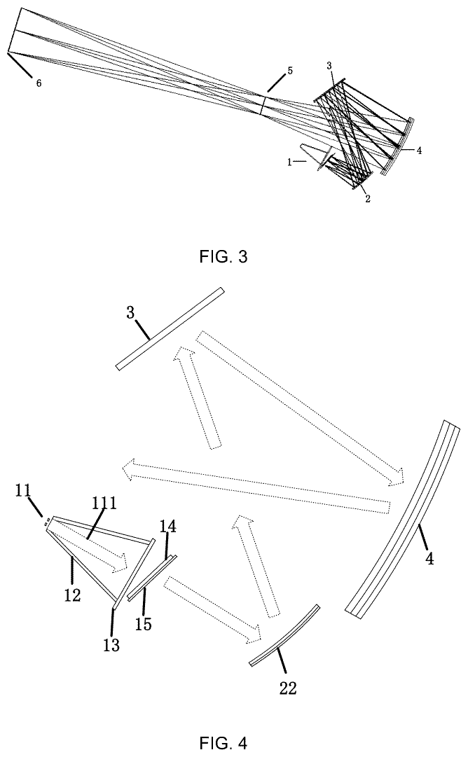

Some embodiments of the present disclosure provide a medium-free projection system, as shown in FIG. 1 and FIG. 3, the medium-free projection system includes: a light source 11; and a light homogenizing rod 12, a first Fresnel lens 13, a thin film crystal liquid crystal display screen 15, a collimating optical element 2, and an imaging optical assembly that are arranged in sequence along a light emergent direction, wherein a divergent beam 111 emitted from the light source 11 is collimated and homogenized by the light homogenizing rod 12 and the first Fresnel lens 13 and then serves as incident light of the thin film crystal liquid crystal display screen 15, and the beam 111 emitted from the thin film crystal liquid crystal display screen 15, after passing through the collimating optical element 2, is converged in a target region by the imaging optical assembly to image, so that the beam at each point of an imaging plane fills an eye box.

Exemplarily, as shown in FIG. 1 and FIG. 3, the medium-free projection system includes: the light source 11, the light homogenizing rod 12, the first Fresnel lens 13, the thin film crystal liquid crystal display screen 15, the collimating optical element 2, and the imaging optical assembly, wherein the light homogenizing rod 12, the first Fresnel lens 13, the thin film crystal liquid crystal display screen 15, the collimating optical element 2, and the imaging optical assembly are arranged in sequence along the light emergent direction, and the light source 11 is located on a light incident side of the light homogenizing rod 12. During operation, the light source 11 emits the divergent beam 111, after passing through the light incident side of the light homogenizing rod 12, the divergent beam 111 is incident on the light homogenizing rod 12, and is emitted from a light emergent side of the light homogenizing rod 12 under collimating and homogenizing effects of the light homogenizing rod 12. The beam 111 is incident from the light incident side of the first Fresnel lens 13 after a primary collimation and homogenization by the light homogenizing rod 12, then is emitted from a light emergent side of the first Fresnel lens 13 under the homogenizing effect of the first Fresnel lens 13, and then is incident from a light incident side of the collimating optical element 2 after passing through the thin film crystal liquid crystal display screen 15. By modifying main lights of the beam of various fields of view through the collimating optical element 2, the main lights of various fields of view of the beam for an imaging part are nearly parallel, and then are emitted towards the imaging optical assembly, finally the beam 111 images in the air of the target region under the converging effect of the imaging optical assembly, so that the beam at each point on an imaging plane fills the eye box, and a real image can be observed by naked eyes in the range of the eye box, so as to realize the medium-free imaging. By providing the light homogenizing rod 12 and the first Fresnel lens 13 between the light source 11 and the thin film crystal liquid crystal display screen 15, the beam emitted from the light source can be primarily collimated and homogenized, so that the brightness and uniformity of the image are improved in an image source stage. Then the collimating optical element 2 is provided on the light emergent side of the thin film crystal liquid crystal display screen 15, the main lights of the beam 111 of various fields of view emitted by the thin film crystal liquid crystal display screen 15 are modified again through the collimating optical element 2, so that the main lights of various fields of view of the beam 111 for the imaging part are nearly parallel, thus further improving the final brightness and brightness uniformity of the imaging in the target region, further realizing clearer image display in the target region, and improving the imaging quality of the final image and the use experience of the users. In addition, the medium-free projection system of the present disclosure has a relatively low cost, and is convenient for mass production and manufacture.

As shown in FIG. 1 and FIG. 3, the imaging is performed in the target region, i.e., converging and imaging is performed at the imaging plane position 5, and in practical use, the range of the eye box 6 also can be located at positions in FIG. 1 and FIG. 3. In this way, the user can be allowed to observe the image suspended in the air by naked eyes in the range of the eye box 6. It should be noted that the eye box in the present disclosure is virtual, and it only represents a spatial range.

An image generation unit 1 of the medium-free projection system can be formed by the light source 11, the light homogenizing rod 12, the first Fresnel lens 13, the thin film crystal liquid crystal display screen 15, etc. The image generation unit 1 can be a micro projection module, wherein the micro projection module includes a projection portion and a projection receiving screen, and the projection portion can include a laser MEMS projection module, a DLP projection module, an LCOS projection module, etc. The thin film crystal liquid crystal display screen 15 can be a display panel having a transmission function.

The collimating optical element 2 may be an imaging lens 21 or may also be a third reflecting mirror 22, and it may participate in imaging. In configuration, reasonable selection can be made according to actual requirements, for example, an object used, a space for installation, and so on. For ease of description, the following description is given by taking the imaging lens 21 and the third reflecting mirror 22 as examples, respectively.

In some embodiments:

as shown in FIG. 1 and FIG. 2, the collimating optical element 2 is the imaging lens 21, that is, the beam 111 is incident from one side of the imaging lens 21 and is emitted from the opposite side, so that the main lights of various fields of view of the beam 111 emitted from the imaging lens 21 are nearly parallel. The imaging lens 21 may be one of a spherical lens, an aspherical lens, and a second Fresnel lens.

As shown in FIG. 1 and FIG. 2, the light homogenizing rod 12 provided between the light source 11 and the first Fresnel lens 13 may be a hollow square conical rod, and an inner wall of the hollow square conical rod is plated with a reflective film, wherein a top surface of the hollow square conical rod is the light incident side, and a bottom surface of the hollow square conical rod is a light emergent side. That is, the light source 11 is provided on the light incident side of the hollow square conical rod, the hollow square conical rod is located on the optical axis of the light source 11, and the first Fresnel lens 13 is attached to the bottom surface of the hollow square conical rod. Herein, the top surface of the hollow square conical rod has an area less than that of the bottom surface of the hollow square conical rod. With such configuration, the large-angle beam emitted from the light source 11 can be collimated into the small-angle beam 111, and is uniformly incident from the first Fresnel lens 13; meanwhile, the beam 111 emitted from the light homogenizing rod 12 also may be further converged and homogenized by the first Fresnel lens 13. In addition, a diffusion film 14 further may be provided at the light incident side of the thin film crystal liquid crystal display screen 15, and the beam 111 incident on the thin film crystal liquid crystal display screen 15 is further homogenized by the diffusion film 14, thus improving the uniformity.

The light source 11 may be an LED light source 11. When positions of the LED light source 11 and the thin film crystal liquid crystal display screen 15 are configured, an optical axis of the LED light source 11 and an optical axis of the thin film crystal liquid crystal display screen 15 can be made to form a certain included angle, as shown in FIG. 1 and FIG. 2. Herein, the thin film crystal liquid crystal display screen 15 is arranged to be inclined at a certain angle with respect to the optical axis of the LED light source 11, and in this way, an angle of the beam 111 for forming an image in the target region can be made to be larger than an angle required to form the image in the target region. The brightness uniformity of the image is improved.

As shown in FIG. 1 and FIG. 2, the imaging optical assembly may include a first reflecting mirror 3 and a second reflecting mirror 4 that are arranged in sequence along the light emergent direction, wherein the beam 111 emitted from the imaging lens 21 is converged in the target region through the first reflecting mirror 3 and the second reflecting mirror 4 in sequence to image. Surface of the first reflecting mirror 3 and the second reflecting mirror 4 may be free curved surface, and certainly, in other embodiments, the surface of the first reflecting mirror 3 and the surface of the second reflecting mirror 4 also may be aspherical surface, spherical surface or planar surface. Besides, a fold-back optical assembly further may be provided, for example, one or more reflecting mirrors are provided, wherein an optical path is folded through the reflecting mirror(s), and a system volume is reduced, so that a device dimension of the final medium-free projection system can be flexibly adjusted, and an application range thereof is improved.

In the present embodiment, illustration is made by taking that the surface of the imaging lens 21 is a spherical surface, the surface of the first reflecting mirror 3 is a free curved surface, and the surface of the second reflecting mirror 4 is a free curved surface as an example.

A focal length of the spherical imaging lens 21 can be greater than 100 mm, an angle of the first Fresnel lens 13 is greater than 40 mm, and a surface formula of the first reflecting mirror 3 and the second reflecting mirror 4 can be:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

In the formula, z is a rise, c is a curvature, k is a conic constant, Aᵢ is an xy multinomial coefficient of an i-th term, and N is number of terms of xy.

In the surface of the first reflecting mirror 3, N is 19, and other parameters are as shown in Table 1.

TABLE 1

| | | | | | |
|---|---|---|---|---|---|
| c | 0.009931 | x³ | −12.226 | xy³ | −4.007 |
| k | −2.089 | x^{y} | −0.049 | y⁴ | −4.67 |
| x | 2.22E+01 | xy² | 12.759 | x⁵ | −31.059 |
| y | 0.205 | y³ | 1.48 | x⁴y | −0.586 |
| x² | −38.389 | x⁴ | 46.789 | x³y² | 5.22 |
| xy | −0.693 | x³y | 0.575 | x²y³ | 3.795 |
| y² | −45.76 | x²y² | 9.643 | xy⁴ | 50.772 |

In the surface of the second reflecting mirror 4, N is 30, other parameters are as shown in Table 2.

TABLE 2

| | | | | | | | |
|---|---|---|---|---|---|---|---|
| c | 0.002267 | x^{y} | −0.0087 | x⁵ | −0.212 | x⁴y² | −0.337 |
| k | −2.571 | xy² | 0.655 | x⁴y | −0.011 | x³y³ | 5.60E−03 |
| x | 4.663 | y³ | 7.91E−03 | x³y² | −0.028 | x²y⁴ | −0.038 |
| y | 0.121 | x⁴ | −0.313 | x²y³ | 7.29E−04 | xy⁵ | 8.12E−03 |
| x² | −0.995 | x³y | −3.40E−04 | xy⁴ | 0.051 | y⁶ | −0.157 |
| xy | −0.074 | x²y² | −0.564 | y⁵ | −0.014 | x⁷ | 0.647 |
| y² | −2.076 | xy³ | −0.012 | x⁶ | 0.133 | x⁶y | 7.11E−03 |
| x³ | 0.624 | y⁴ | −0.228 | x⁵y | −0.027 | x⁵y² | 0.046 |

In this way, the angle difference of various main lights can be controlled within a range of less than 4 degrees, so that both the image brightness and uniformity within the range of the eye box 6 are higher than 70%.

In some other embodiments:

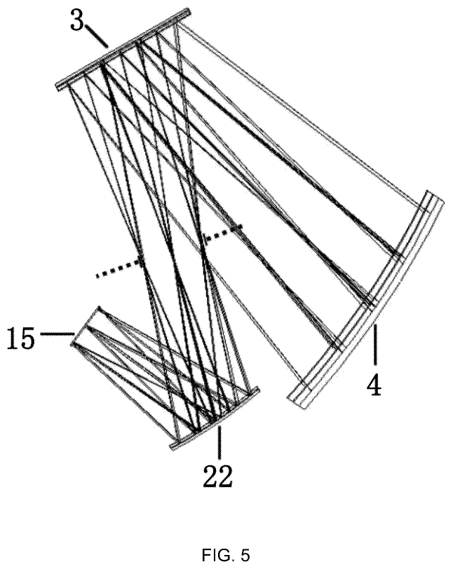

as shown in FIG. 3, FIG. 4, and FIG. 5, the difference from the previous embodiment lies in that the collimating optical element 2 is a third reflecting mirror 22, i.e., the beam 111 is incident from the same side as the third reflecting mirror 22 and exits from the same side, so that the main lights of various fields of view of the beam 111 emitted from the third reflecting mirror 22 are nearly parallel, wherein the smaller the angle difference between the main lights of various fields of view is, the larger an exit pupil is, the larger a numerical aperture of the beam 111 is, and the higher the brightness is. The surface of the third reflecting mirror 22 may be one of a spherical surface, an aspherical surface, a planar surface, and a free curved surface.

As shown in FIG. 4, when the light homogenizing rod 12 is arranged, reference can be made to the forms in the above embodiments. For example, the light homogenizing rod 12 arranged between the light source 11 and the first Fresnel lens 13 may be a hollow square conical rod, wherein a reflective film is plated on an inner wall of the hollow square conical rod. A top surface of the hollow square conical rod is a light incident side, and a bottom surface of the hollow square conical rod is a light emergent side. That is, the light source 11 is provided on the light incident side of the hollow square conical rod, the hollow square conical rod is located on the optical axis of the light source 11, and the first Fresnel lens 13 is attached to the bottom surface of the hollow square conical rod, wherein the top surface of the hollow square conical rod has an area less than that of the bottom surface of the hollow square conical rod. With such configuration, the large-angle beam emitted from the light source 11 can be collimated into the small-angle beam 111 and is uniformly incident from the first Fresnel lens 13; and meanwhile, the beam 111 emitted from the light homogenizing rod 12 also may be further converged and homogenized by the first Fresnel lens 13. In addition, a diffusion film 14 further may be provided at the light incident side of the thin film crystal liquid crystal display screen 15, and the beam 111 incident on the thin film crystal liquid crystal display screen 15 is further homogenized by the diffusion film 14, thus improving the uniformity.

Certainly, for the light source 11, reference also may be made to the above embodiments, that is, the light source 11 may be an LED light source 11. When positions of the LED light source 11 and the thin film crystal liquid crystal display screen 15 are configured, an optical axis of the LED light source 11 and an optical axis of the thin film crystal liquid crystal display screen 15 can be made to form a certain included angle, as shown in FIG. 4. The thin film crystal liquid crystal display screen 15 is arranged to be inclined at a certain angle with respect to the optical axis of the LED light source 11, and in this way, an angle of the beam 111 for imaging in the target region can be made larger than an angle required for imaging in the target region. The brightness uniformity of the image is improved.

As shown in FIG. 4, the imaging optical assembly may include a first reflecting mirror 3 and a second reflecting mirror 4 that are arranged in sequence along the light emergent direction, and the beam 111 emitted from the third reflecting mirror 22 is converged in the target region through the first reflecting mirror 3 and the second reflecting mirror 4 in sequence to image. Surface of the first reflecting mirror 3 and the second reflecting mirror 4 may be free curved surface. Certainly, in other embodiments, the surface of the first reflecting mirror 3 and the second reflecting mirror 4 also may be aspherical surface, spherical surface or planar surface. Besides, a fold-back optical assembly further may be provided. For example, one or more reflecting mirrors are provided, an optical path is folded through the reflecting mirror(s), and a system volume is reduced, so that a device dimension of the final medium-free projection system can be flexibly adjusted, and an application range thereof is improved.

In this embodiment, illustration is made by taking that the surface of the third reflecting mirror lens 22 is a spherical surface, the surface of the first reflecting mirror 3 is a free curved surface, and the surface of the second reflecting mirror 4 is a free curved surface as an example.

A focal length of the first Fresnel lens 13 is greater than 40 mm; a focal length of the third reflecting mirror 22 may be greater than 100 mm; a y-direction focal length of the first reflecting mirror 3 may be greater than 200 mm, and a surface thereof is free curved surface; a y-direction focal length of the second reflecting mirror 4 is greater than 100 mm, and a surface thereof is also free curved surface; and a surface formula of the first reflecting mirror 3 and the second reflecting mirror 4 can be:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

In the formula, z is rise, c is curvature, k is conic constant, Aᵢ is xy multinomial coefficient of an i-th term, and N is number of terms of xy.

In the surface of the first reflecting mirror 3, N is 20, and other parameters are as shown in Table 3.

TABLE 3

| | | | | | |
|---|---|---|---|---|---|
| c | 0.001294 | x^{y} | −0.011 | x⁵ | −0.285 |
| k | −1 | xy² | −0.268 | x⁴y | −0.022 |
| x | −0.271 | y³ | −2.00E−02 | x³y² | −1.968 |
| y | −0.764 | x⁴ | 0.281 | x²y³ | 1.50E−02 |
| x² | −5.077 | x³y | −3.64E−01 | xy⁴ | −0.405 |
| xy | 0.037 | x²y² | −0.03 | y⁵ | 0.059 |
| y² | −2.708 | xy³ | −0.061 | | |
| x³ | −1.071 | y⁴ | −0.555 | | |

In the surface of the second reflecting mirror 4, N is 30, and other parameters are as shown in Table 4.

TABLE 4

| | | | | | | | |
|---|---|---|---|---|---|---|---|
| c | −0.0021 | x^{y} | −2.761 | x⁵ | −0.270 | x⁴y² | −0.129 |
| k | −0.746 | xy² | 0.193 | x⁴y | −3.64E−03 | x³y³ | 7.68E−03 |
| x | −0.498 | y³ | 6.21E−03 | x³y² | −0.381 | x²y⁴ | −2.90E−02 |
| y | −0.233 | x⁴ | −0.074 | x²y³ | −5.34E−03 | xy⁵ | −1.03E−03 |
| x² | 2.65 | x³y | 3.13E−03 | xy⁴ | 4.37E−02 | y⁶ | −0.012 |
| xy | 0.013 | x²y² | 0.017 | y⁵ | 1.63E−04 | x⁷ | 0.033 |
| y² | 3.61 | xy³ | −8.28E−03 | x⁶ | 5.439E−01 | x⁶y | 6.43E−03 |
| x³ | −0.115 | y⁴ | −1.07E−01 | x⁵y | 1.91E−03 | x⁵y² | 3.69E−02 |

The above-mentioned are merely for preferred embodiments of the present disclosure and not used to limit the present disclosure. For one skilled in the art, various modifications and changes may be made to the present disclosure. Any modifications, equivalent substitutions, improvements and so on, within the spirit and principle of the present disclosure, should be covered within the scope of protection of the present disclosure.

### INDUSTRIAL APPLICABILITY

The present disclosure provides a medium-free projection system, wherein the medium-free projection system includes: a divergent beam emitted from a light source is collimated and homogenized by a light homogenizing rod and a first Fresnel lens and then serves as incident light of a thin film crystal liquid crystal display screen, and a beam emitted from the thin film crystal liquid crystal display screen, after passing through a collimating optical element, is converged in a target region by an imaging optical assembly to image, so that the beam at each point on an imaging plane fills an eye box. That is, the image suspended in the air can be viewed by naked eyes in the range of the eye box, thus realizing a medium-free projection. By providing the light homogenizing rod and the first Fresnel lens between the light source and the thin film crystal liquid crystal display screen, and providing the collimating optical element on the light emergent side of the thin film crystal liquid crystal display screen, the main lights of various fields of view of the beam for an imaging part are nearly parallel, thus further improving the brightness and brightness uniformity of imaging in the target region, further realizing clearer image display in the target region, and improving the imaging quality of the final image and the use experience of the users.

Besides, it may be understood that the medium-free projection system of the present disclosure can be reproduced, and can be used in a variety of industrial applications. For example, the medium-free projection system of the present disclosure can be used in the field of optical technologies.

1. A medium-free projection system, comprising: a light source; and a light homogenizing rod, a first Fresnel lens, a thin film crystal liquid crystal display screen, a collimating optical element, and an imaging optical assembly that are arranged in sequence along a light emergent direction, wherein a divergent beam emitted from the light source is collimated and homogenized by the light homogenizing rod and the first Fresnel lens and then serves as an incident light of the thin film crystal liquid crystal display screen, and the beam emitted from the thin film crystal liquid crystal display screen, after passing through the collimating optical element, is converged in a target region by the imaging optical assembly to image, so that the beam at each point on an imaging plane fills an eye box.

2. The medium-free projection system according to claim 1, wherein the thin film crystal liquid crystal display screen is a display panel with a transmission function.

3. The medium-free projection system according to claim 1, wherein the light source is an LED light source.

4. The medium-free projection system according to claim 1, wherein the imaging optical assembly comprises a first reflecting mirror and a second reflecting mirror that are arranged in sequence along the light emergent direction, and the beam emitted from the collimating optical element is converged in the target region through the first reflecting mirror and the second reflecting mirror in sequence to image.

5. The medium-free projection system according to claim 4, wherein a surface of the first reflecting mirror and a surface of the second reflecting mirror are both free curved surfaces.

6. The medium-free projection system according to claim 1, wherein a diffusion film is provided at a light incident side of the thin film crystal liquid crystal display screen.

7. The medium-free projection system according to claim 3, wherein an optical axis of the LED light source and an optical axis of the thin film crystal liquid crystal display screen form a certain included angle.

8. The medium-free projection system according to claim 1, wherein the light homogenizing rod is a hollow square conical rod, an inner wall of the hollow square conical rod is plated with a reflective film, a top surface of the hollow square conical rod is a light incident side, a bottom surface of the hollow square conical rod is a light emergent side, and the top surface of the hollow square conical rod has an area less than that of the bottom surface of the hollow square conical rod.

9. The medium-free projection system according to claim 1, wherein the collimating optical element is an imaging lens.

10. The medium-free projection system according to claim 9, wherein the imaging lens is a spherical lens, an aspherical lens or a second Fresnel lens.

11. The medium-free projection system according to claim 1, wherein the collimating optical element is a third reflecting mirror, and a surface of the third reflecting mirror is a spherical surface, an aspherical surface, or a free curved surface.

12. The medium-free projection system according to claim 1, further comprising a fold-back optical assembly, wherein the fold-back optical assembly is configured to fold an optical path.

13. The medium-free projection system according to claim 12, wherein the fold-back optical assembly is one or more reflecting mirrors, and the optical path is folded by the reflecting mirror or mirrors.

14. The medium-free projection system according to claim 2, wherein the light source is an LED light source.

15. The medium-free projection system according to claim 2, wherein the imaging optical assembly comprises a first reflecting mirror and a second reflecting mirror that are arranged in sequence along the light emergent direction, and the beam emitted from the collimating optical element is converged in the target region through the first reflecting mirror and the second reflecting mirror in sequence to image.

16. The medium-free projection system according to claim 3, wherein the imaging optical assembly comprises a first reflecting mirror and a second reflecting mirror that are arranged in sequence along the light emergent direction, and the beam emitted from the collimating optical element is converged in the target region through the first reflecting mirror and the second reflecting mirror in sequence to image.

17. The medium-free projection system according to claim 2, wherein a diffusion film is provided at a light incident side of the thin film crystal liquid crystal display screen.

18. The medium-free projection system according to claim 3, wherein a diffusion film is provided at a light incident side of the thin film crystal liquid crystal display screen.

19. The medium-free projection system according to claim 4, wherein a diffusion film is provided at a light incident side of the thin film crystal liquid crystal display screen.

20. The medium-free projection system according to claim 5, wherein a diffusion film is provided at a light incident side of the thin film crystal liquid crystal display screen.
